(19) United States
(12) Patent Application Publication
(10) Pub. No.: US 2003/0128324 A1
(43) Pub. Date: Jul. 10, 2003

(54) Pixel size enhancements

(76) Inventors: Daniel D. Woods, Longmont, CO (US); Kenton J. Pharris, Longmont, CO (US)

Correspondence Address: Stephen C. Durant, Morrison & Foerster LLP, 425 Market St., San Francisco, CA, 94105-2482, US

(21) Appl. No.: 10/286,663

(22) Filed: Nov. 1, 2002

Related U.S. Application Data
(60) Provisional application No. 60/333,457, filed on Nov. 27, 2001.

(51) Int. Cl. G02F 1/1343

(52) U.S. Cl. 349/143

(57) ABSTRACT

An optical encoder or decoder including an array of addressable elements with varying sized pixels. The optical encoder or decoder includes an array of addressable elements configured with a first set of pixels of a first size, where the first set of pixels each include at least one addressable element of the array of addressable elements. The array of addressable elements further includes a second set of pixels of a second size, where the second set of pixels each include at least one addressable element of the array of addressable elements and the second size of pixels is greater than the first size of pixels.

### CROSS-REFERENCE TO RELATED APPLICATIONS

The present application claims priority of an earlier filed provisional application U.S. Serial No. 60/333,457, entitled PIXEL SIZE ENHANCEMENTS, filed on Nov. 27, 2001, and is incorporated in its entirety herein by reference.

### BACKGROUND

1. Field of the Invention

The invention relates generally to an array of addressable elements of an optical system, and more particularly to a method and structure for an array of addressable elements for an optical system with varying pixel sizes.

2. Description of the Related Art

Many optical systems include an array of addressable elements that are used to produce or detect images such as a spatial light modulator (SLM) or photodetector array. An SLM, for example, typically consists of a planar array of addressable elements where each addressable element acts as an individual shutter or light valve that can be addressed to either block light or allow light to pass. Two common SLMs are liquid crystal displays (LCD), such as transmissive LCD panels or transmissive field-effect transistor (TFT) panels, and reflective SLMs such as reflective LCD panels or mechanical micro-mirror devices. Reflective type SLMs include an array of elements that either reflect or do not reflect incident light to produce an image similar to a transmissive SLM.

Typical SLM systems operate by addressing individual elements or pixels of the planar array while directing coherent light from a laser at the SLM. A pixel generally includes one or more addressable elements of the array and corresponds to a single dot among an array of thousands or millions of similar sized dots. The dot might correspond to a pixel of an image or a unit of data from a data page. Common SLM and detector arrays may have pixel arrays of 1024 by 1024 or greater depending on the particular application. Each of these pixels may further be sub-divided into individually addressable elements. The light passing through (or reflected from) an SLM is modulated according to a code rate or addressing scheme of the array of addressable elements to create a desired image or pattern of light. For example, pixels of two addressable elements each are encoded at a rate of 2 elements per pixel. A detector array can operate similarly by receiving an image or light beam and decoding the data from the array of addressable elements at a rate corresponding to a particular pixel size to create an image or data page.

Performance of an SLM, i.e., the quality of the modulated image, depends in part on the uniformity of the light beam incident upon the array of addressable elements. Typically, the optical spot of the light beam has a Gaussian distribution, in that it is brightest or strongest in the center and diminishes with distance from the optical spot. Assuming the optical spot is directed towards the center of the SLM the outer most pixels of the SLM receive less light than those pixels located near the center, i.e., near the optical spot. This results in strong signals near the center and weaker signals near the edges. Consequently, it is more difficult to create a densely pixilated image in weak areas of the signal with uniform sized pixels. Additionally, other factors, such as a varying signal-to-noise ratio (SNR) across the SLM and inter-pixel interference (IPI) can cause errors in a modulated or detected image. Increasing the uniformity of the incident light beam upon the SLM increases the quality of the modulated image. To increase the uniformity and reduce unwanted effects such as varying SNR and IPI, the light beam can be manipulated with optical elements and tighter mechanical tolerances in an attempt to create a more uniform intensity light beam across the area of the SLM.

Similar performance issues may arise with detector arrays when detecting or imaging light beams with non-uniform intensities or other light distortions. Specifically, areas of the signal or light beam that are weak are often more difficult for a photo-detector array to detect or image correctly with uniform sized pixels. Again, these difficulties can be corrected to some degree by manipulating the light beam with optical elements.

Therefore, in optical systems that use an array of addressable elements, distortions induced by non-ideal system conditions, mechanical misalignments, and the like can degrade the device performance, in part, by causing non-uniform intensity of light across the array. To correct various distortions and increase uniformity it is generally required to resort to higher quality optics and tighter mechanical tolerances. Such solutions to distortion and non-uniform light images and beams generally require costly and/or difficult manufacturing processes to produce or detect higher quality images.

### BRIEF SUMMARY

In one exemplary embodiment, an optical encoding or decoding device including an array of addressable elements is provided. The addressable elements are addressed in groups of one or more addressable elements to form a plurality of different sized pixels. The array of addressable elements includes a first set of pixels of a first size, and a second set of pixels of a second size. The second size of pixels is greater than the first size of pixels.

In another exemplary embodiment, a method is provided for addressing an array of individually addressable elements of an encoding or decoding device. The method includes addressing the addressable elements of the array in groups of one or more addressable elements to correspond to pixels having different numbers of addressable elements, and including two or more different size pixels.

The present invention is better understood upon consideration of the detailed description below in conjunction with the accompanying drawings and claims.

### BRIEF DESCRIPTION OF THE DRAWINGS

FIG. 1A is a schematic illustration of an exemplary application of an optical system with an array of addressable elements.

FIG. 1B is a schematic illustration of an exemplary array of addressable elements for an optical system.

FIG. 2 is an illustration of an exemplary array of addressable elements configured with varying pixel sizes.

FIGS. 3A through 3J are illustrations of exemplary pixel configuration of addressable elements.

FIG. 4 is a flow chart of an exemplary process for addressing individual elements of an array corresponding to varying pixel sizes.

FIG. 5 is an illustration of an exemplary array of addressable elements configured with varying pixel sizes.

FIG. 6 is an illustration of an exemplary array of addressable elements configured with varying pixel sizes.

### DETAILED DESCRIPTION OF THE PREFERRED EMBODIMENTS

In order to provide a more thorough understanding of the present invention, the following description sets forth numerous specific details, such as specific materials, techniques, applications, and the like. It should be recognized, however, that the description is not intended as a limitation on the scope of the present invention, but is instead provided to enable a better description of the exemplary embodiments.

Optical signals created with and detected by arrays of addressable elements, such as a spatial light modulator (SLM) or a photo-detector array, typically suffer from distortions induced by non-ideal system conditions. For example, often images created by a SLM suffer from non-uniform quality over its extent, i.e., the center of the image may be of higher quality than the edge, as can be characterized by “signal-to-noise ratios” of the system. Such distortions can be cause by many factors, such as poor optical components, mechanical misalignment, or the like. A primary source of distortions in the light beam is that an optical spot of the light beam is typically centered with the array and has a Gaussian distribution that reduces in intensity with distance from the center. Rather than attempting to address these problems by altering optical and mechanical components of the system that create and direct the light or image beams, the pattern of addressable elements of the array can be modified or grouped together in different sized pixels to achieve improved image quality or detection.

In one example an optical system with an array of addressable elements includes a plurality of pixels that each include at least one addressable element. In general, a pixel includes one or more addressable elements of an array that are addressed together as a single “spot” or unit of information such as a particular color or pixel of a display, or a “1” or “0” of a data page. One or more of the addressable elements, sometimes referred to as sub-pixels, can be addressed together as single pixels of different sizes. The array of addressable elements are configured, for example, into a first set of pixels of a first size and a second set of pixel of a second size, where the second size is larger than the first size. The difference in size of the pixels can be determined by the number of addressable elements grouped or addressed together within each pixel and/or based on the physical size of the addressable elements within each pixel. For example, an array of uniform sized elements can be addressed, i.e., encoded or decoded, in groups of addressable elements where the groups are configured into varying sized pixels. In another example, the array of elements can be created as varying sized elements; for example, two elements of different physical sizes can correspond to two pixels of different sizes. The configuration of addressable pixels can be used in optical systems that utilize arrays of addressable elements, such as SLM devices, both reflective and transmissive, micro-mirror devices, detector arrays, cameras, imaging devices, holographic storages, LCD displays, projection displays, printers, and the like.

Further, in one example, the greatest amount of information in terms of pixels is located in the region of the array of addressable elements where the light beam intensity or signal quality is the greatest. Often, the intensity or signal quality is greatest near the center of the array. For example, with an SLM, smaller physical pixels placed closer together can encode a greater amount of information than larger or farther apart pixels, but are more difficult to image and more susceptible to image quality problems. Thus, relatively smaller pixels are placed or addressed where the signal quality or beam intensity is strong to exploit this region of the signal with higher resolution and more densely configured pixels. In contrast, larger physical pixels placed or addressed farther apart carry less information content, but are easier to image and less susceptible to image quality problems in the poor signal quality regions. Therefore, by using physically smaller pixels in high-quality regions of the beam, and physically larger pixels in relatively low-quality regions of the beam, an image modulated by the SLM can be created with decreased image distortion and high information content. It should be recognized that other arrays of addressable elements such as a detector array can be configured or grouped in a similar fashion either to compensate for distortions of an optical system, such as an image, or to correspond to a similarly configured or grouped SLM.

One exemplary application of an array of addressable elements with varying pixel sizes includes holographic storage systems. A holographic storage system is used here for illustrative purposes, in part, because of the utilization of both an encoder and a decoder, i.e., an SLM and a detector array, both of which include an array of addressable elements to encode and decode a light beam with information. It should be understood, however, that the exemplary SLMs and detector arrays, in particular the configuration and grouping of addressable elements, may be used in other applications such as LCD displays, cameras, optical printing heads, display devices, imaging devices, and the like.

Holographic memory systems generally involve the three-dimensional storage of holographic representations (i.e. holograms) of data elements as a pattern of varying refractive index and/or absorption imprinted in a volume of a storage or recording medium such as a photopolymer or photorefractive crystal. Combining a data-encoded signal beam, i.e., an object beam, with a reference beam can create an interference pattern. An SLM, for example, can create the data-encoded signal beam. The interference pattern induces material alterations in the storage medium that generate a hologram. The formation of the hologram in the storage medium is a function of the relative amplitudes and polarization states of, and phase differences between, the signal beam and the reference beam. It is also highly dependent on the incident beam's wavelengths and angles at which the signal beam and the reference beam are projected into the storage medium. Projecting the reference beam into the storage medium to interact and reconstruct the original data-encoded signal beam can retrieve the stored data. The reconstructed signal beam is then detected by using, for example, a photo-detector array. The recovered data may then be decoded by the photo-detector array into the original data.

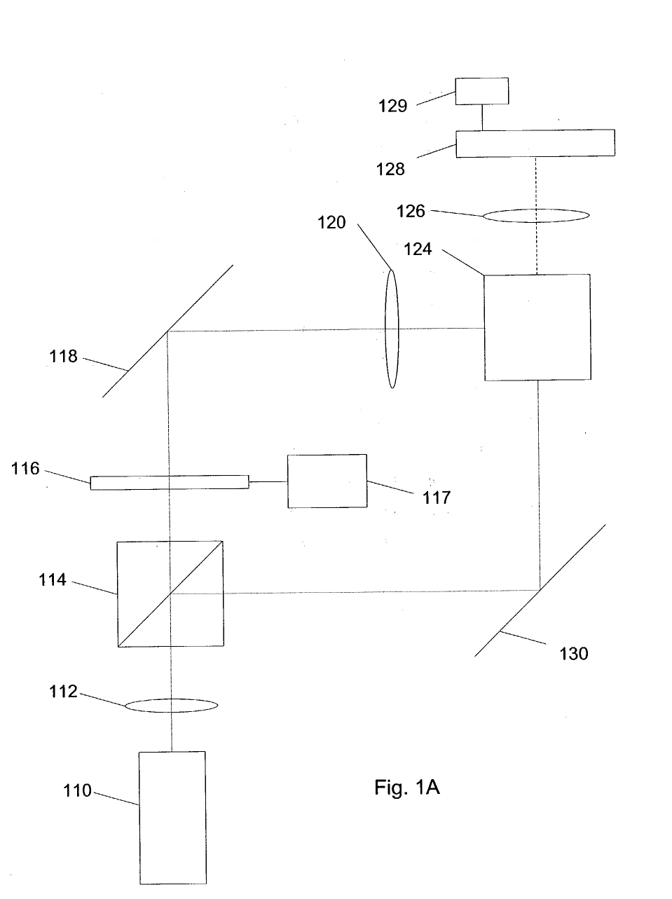

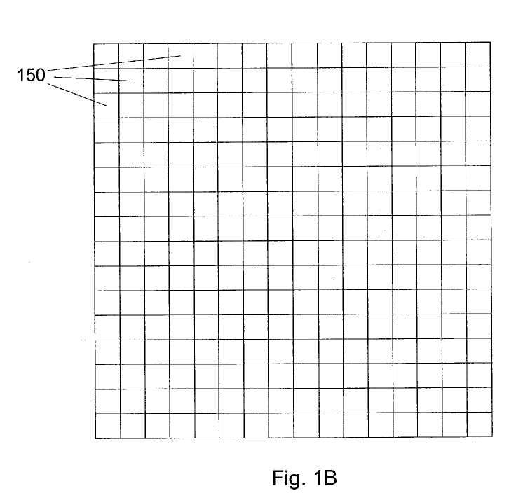

FIG. 1A is a schematic illustration of an exemplary holographic storage system that includes an SLM 116 and camera or detector array 128. For example, a 1280×768 pixel SLM coupled with a 1280×1023 pixel camera or the like may be used. Preferably, however, SLM 116 and camera or detector array 128 are the same or similar size to increase efficiency. The holographic storage device includes a light source 110, for example, a laser for providing a coherent beam of light. A beam splitter 114 is positioned to split the laser beam into an object beam and a reference beam. The object beam is directed to SLM 116 where it is encoded, for example, by encoding unit 117, with data associated with the data page that creates the two-dimensional image. Encoding unit 117 can include software and/or hardware capable of encoding data sequences into varying sized pixels by appropriately addressing the array of addressable elements. The varying sized pixels are determined by the number of pixels addressed per pixel or bit of information in the encoded image. The signal beam, modulated with a data page image, is then directed to the recording material 124. Encoding data on SLM 116 and reading various detector array 128 pixels is well known in the art. For example, a microcontroller including a decoder and/or encoder, or the like may address the SLM 116 and detector array 128 through firmware commands or the like.

An exemplary pattern of addressable elements for SLM 116, or detector array 124 (see below) is illustrated in FIG. 1B. The pattern or array of addressable elements is composed of a plurality of individually addressable elements 150. Each individually addressable element 150 can correspond to an individual pixel. Additionally, one or more addressable elements 150 can be grouped together by addressing the elements within a group to operate in the “on” or “off” state together as a single pixel or bit of information.

Each addressable element may include a liquid crystal cell comprising a liquid crystalline material sandwiched between two electrodes and two polarizers that are rotated 90° with respect to each other. In a first state, the liquid crystal elements are transmissive to light by changing the polarization of incident light. In a second state, the liquid crystal elements are non-transmissive by allowing the incident light to pass unchanged. In some configurations, however, the elements are transmissive when allowing the light to pass unchanged and become non-transmissive by changing the polarization of the incident light. By appropriately addressing the array of elements, SLM 116 modulates the object beam into a two-dimensional image or data page comprising an array of pixels that may correspond to binary data units to be stored in the recording medium 124.

In other optical systems, SLM 116 may operate to create a visual image, such as in a LCD panel display, projection display, or the like. Additionally, it should be recognized that numerous other types of SLMs are possible, including reflective SLMs such as reflective LCD panels and micro-mirror devices. Reflective SLMs operate in a similar manner as transmissive SLMs, with the “on” and “off” state consisting generally of reflecting and non-reflecting states. Thus, SLM 116 can be any device capable of optically representing data in two-dimensions.

The modulated object beam encoded with data is directed towards recording medium 124 where it intersects the reference beam in the recording medium to form a complex interference pattern. The complex interference pattern is recorded in the recording medium 124. After one page of data is recorded, the storage device can be modified to enable additional pages to be recorded in recording medium 124. For example, by modifying the angle and/or wavelength of the reference beam, successive data pages can be recorded in the recording medium 124.

The data page can be retrieved from recording medium 124 with a reference beam similar to the original reference beam used to store the data page. The light is diffracted by recording medium 124 according to the data page and the two-dimensional data page image that was stored in recording medium 124 is directed by lens 126 to photo-detector array 128. Photo-detector array 128 is, for example, an array of charge-coupled devices (CCDs) or a complementary metal-oxide-semiconductor (CMOS) detector array that captures the data page image. The data retrieved corresponds to intensity values for each element of the detector array that can then be converted to individual pixels depending on the addressing scheme, i.e., the number of elements included within each pixel or bit of data. The scheme of addressing the elements can then be used to convert the data back into the original data page and conventional binary data formats by a decoding unit 129. Decoding unit 129 will decode the addressable elements of the array according to a specific pixel size configuration, generally, the pixel size at which the data was stored.

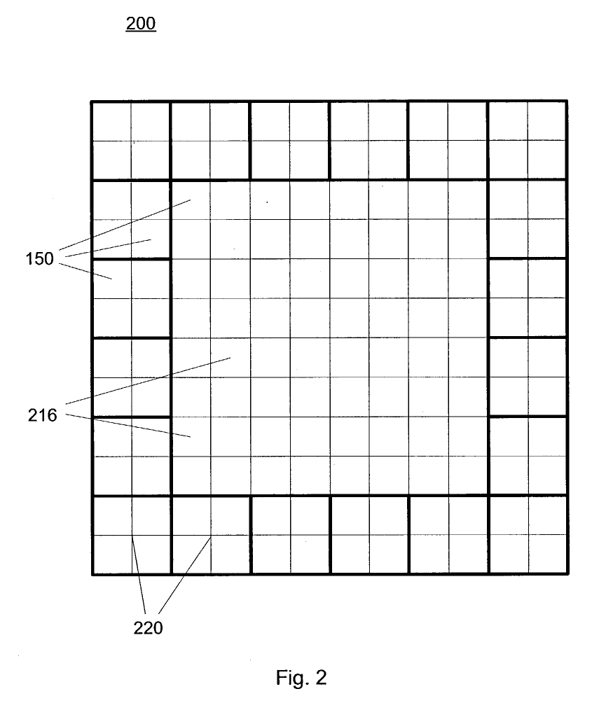

FIG. 2 is an exemplary array configuration 200, including an array of addressable elements 150. In this example, the addressable elements 150 are of a uniform size and equally spaced in a grid pattern. The shape of the addressable elements 150 may be square, rectangles, stripes, circles, or the like. Further, addressable elements 150, for example, of an SLM, may be arranged in aligned or offset rows and columns. Each individual element 150 can be individually addressed and turned to an “on” or “off” state thereby becoming transmissive to incident light in one state and at least partially blocking incident light in a second state.

Array configuration 200 is configured or grouped into an array of pixels 216 and 220. In general, a pixel is one or more addressable elements of an array that are addressed together as a single unit of information such as 1 or 0 in a data page, or a particular color or pixel of a displayed image. Array configuration 200 includes a region of uniform sized pixels 216 in the center region and a region of larger pixels 220 near the edge or boarder regions of array configuration 200. In this example, each pixel 216 includes one element 150 and each pixel 220 includes four adjacent elements 150. Each pixel 220, which includes more than one element is not a physical grouping; rather, it refers to the grouping of more than one element into a single pixel that is encoded with data, or turned to an “on” or “off” state as a single unit. The darker lines of FIG. 2 indicate the grouping of elements 150 into pixels 220 and how the code rate addresses the array for configuring, i.e., encoding or decoding, the elements 150 into pixels 216 and 220.

Grouping the addressable elements into varying size pixels is achieved, as discussed above, by addressing groups of the one or more elements together as a single pixel or unit of data. The different sized groups of elements correspond to different sized pixels. An addressing rate or code rate is the rate at which the elements are addressed and grouped into varying sized pixels, such as with an SLM to encode a light beam, or a photo-detector array to decode a light beam. For example, array configuration 200 would be addressed at varying address rates of 1 element per bit and 4 elements per bit for pixels 216 and 220, corresponding to 1 and 4 elements 150 per pixel 216 and 220 respectfully. Increasing the number of addressable elements per bit or pixel reduces the information content in terms of bits or pixels per area. Decreasing the number of elements addressed per bit or pixel may be used over areas of the array subject to high intensity light to store or retrieve information with smaller more densely arranged pixels than areas of the array subject to low intensity light. The different sized pixels are implemented, for example, via an encoder or decoder unit that is capable of addressing an array of elements to transform data into different sized pixels or bits of an image or data page.

The larger pixels 220 are arranged around the boarder of array configuration 200. In general, the larger pixels 220 are positioned in areas of array configuration 200 where light from a light source is weaker and/or susceptible to image quality problems. For example, as discussed above, a typical light source may have an optical spot located at the center of array configuration 200, for example a Gaussian distribution, with weaker portions of the optical spot located in the outer or boarder regions of array configuration 200. The signal-to-noise ratio (SNR) therefore deteriorates near the edges of the array where the signal intensity falls off. The larger pixels 220, however, receive more of the incident light beam than a smaller pixel in the same region thereby reducing or compensating for common distortion effects of pixels near the edges of an array. The configuration of larger sized pixels 220 of array configuration 200 can create a more constant (SNR) across the array.

The design further mitigates inter-pixel interference (IPI). IPI can be characterized, for example, by an “off” pixel among adjacent “on” pixels being detected or imaged as an “on” pixel (or vice versa). One cause of IPI is that insufficient light intensity with respect to the size of the adjacent pixels is used. Array configuration 200 can therefore be used to reduce IPI because the pixel sizes can be adjusted based on the light or signal intensity. Reducing IPI further reduces the need for modulation codes, such as an 8:12 modulation code commonly used to reduce the likelihood of an “off” pixel surrounded by “on” pixels (or vice versa). A modulation code works with an encoder to format pixels corresponding to data of a two-dimensional data page into patterns of uniform sized small blocks in a manner such that when the blocks are adjacent to each other problematic IPI configurations are not formed. Another option is differential encoding where a pair of pixels are used to represent each bit such that “on, off” represents a bit equal to 1, and “off, on” represents a bit equal to zero. The drawback of modulation codes is that they reduce the data capacity of an individual data page by requiring two-pixels per unit of information and therefore a loss in data capacity.

It should be noted, however, that by grouping the addressable elements 150 of array configuration 200 into varying sized pixels the total number of pixels that are included in array configuration 200 are less than if each pixel corresponded to one addressable element 150. For example, less data can be stored on a single data page. However, by creating a more constant SNR and reducing the effect of IPI, the need for modulation codes and differential coding is eliminated, or at least reduced to less burdensome methods. The data capacity lost in configuring the addressable elements as larger pixels can be offset, at least in part, by the gain in addressable elements from reducing the need for a modulation code or differential encoding. In some applications the overall information capacity can be increased.

It should be noted that an actual array configuration 200 for use with an SLM, detector array, or other optical system might include a million or more pixels, for example, commonly available LCD panels include 1024 by 1024 pixels. The number of uniform sized pixels 216 in the center region can far exceed the number of larger pixels 220 near the boarder regions depending on the uniformity of the incident light beam and the application. The larger pixels 220 located near the low intensity regions, in this example near the boarder region, may consist of a plurality of rows of pixels 220 surrounding the smaller pixel 216 region. Additionally, the non-uniformity concerns, i.e., the weak spots, may be located in other areas of array configuration 200. Therefore, pixels 220 can be located in regions of array configuration 200 other than near the edges. Also, there may be more than one region of different sized pixels depending on the intensity and distortion of the pattern.

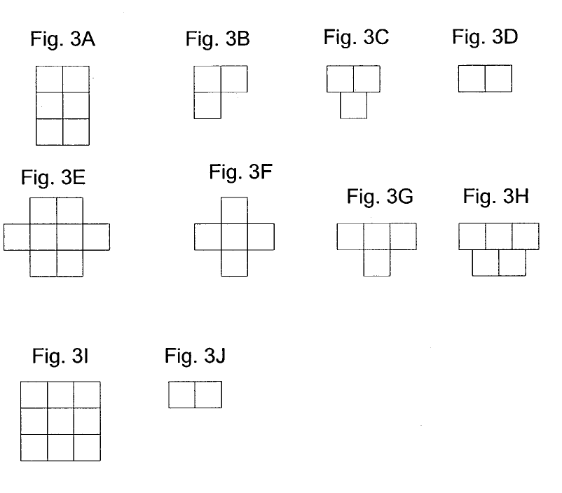

Further, various shapes and configuration of different sized pixels are possible. For example, the number of elements 150 that are used to form a single pixel can vary depending on the non-uniformity of the incident light and other factors such as the application and desired image or detection quality. The grouping of elements 150 of a pixel 220 may include a single row of two or more elements 150 as opposed to a square or rectangle configuration of elements 150. Additionally, pixel 220 could consist of three or more elements 150 arranged in a triangle or delta shape. FIGS. 3A through 3J show various examples of possible pixel configurations. It should be recognized, however, that FIGS. 3A through 3J are not intended to be exhaustive and other various sizes and configurations are possible depending on the particular application.

Array configuration 200 can be used with an SLM such as a transmissive or reflective LCD, micro-mirror device, or the like. Array configuration 200 can equally be used with a detector array such as a camera, image device, or the like that includes a two-dimensional array of detectors such as CCDs or CMOS detectors. For example in FIG. 1 the stored data is read out of recording material 124 using the reference beam to generate an image of the data page with the same pixel configuration used by SLM 116 to store the data page. Detector array 128 can be configured in a complementary manner with respect to array configuration 200. For example, the array elements can be configured or grouped into pixels of the same size, shape, and location as array configuration 200 by decoding the array elements at a rate corresponding to the pixels encoded to SLM 116. Each addressable element of the detector array 129 receives an intensity of light that is detected or measured and sent to a decoder unit or the like to determine if the pixels are “on” or “off.,” based on the intensity values. Therefore, configuring or coding the elements of the detector array 128 with pixels corresponding to the SLM 116 allows for the data to be read out according to the manner in which it was stored. It should be recognized of course, that detector arrays, such as cameras and imaging devices, may use exemplary array configuration 200 independently of an image or data page created with a similar array configuration.

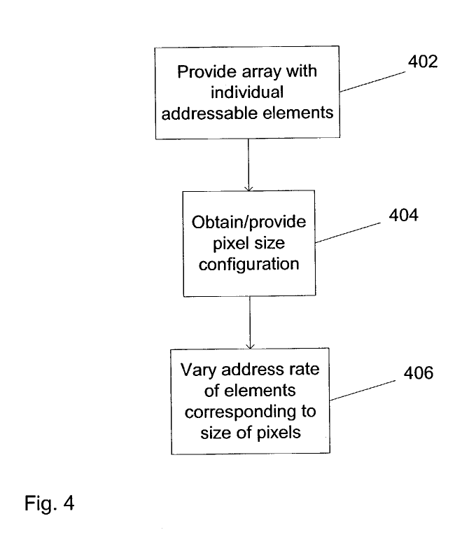

FIG. 4 is an exemplary flow chart of a process for addressing an array of elements configured with varying sized pixels where the pixels include different numbers of addressable elements. In block 402 a device with an array of individually addressable elements is provided. A pixel configuration, i.e., the varying number of elements per bit or pixel, is obtained or determined in block 404. The address scheme or rate, i.e., the number of elements per pixel or bit of data, is then varied over the array of addressable elements corresponding to the different sized pixels in block 406. The address rate generally refers to the manner in which individual elements are addressed and configured as individual pixels. For example, in an encoding process, the pixel configuration can be defined and set by an encoding unit and encoded to the array of addressable elements accordingly. In a decoding process, the pixel configuration and the address rate are determined, for example, by pre-defining a decoding rate, a header included in the data page itself, or the like. The “raw” data from the array of addressable elements can then be decoded according to the address rate by a decoding unit after the data from each addressable element is received.

It should be recognized that numerous modifications can be made to the process depicted in the flow chart. For example, numerous other processes that are not explicitly described may be included.

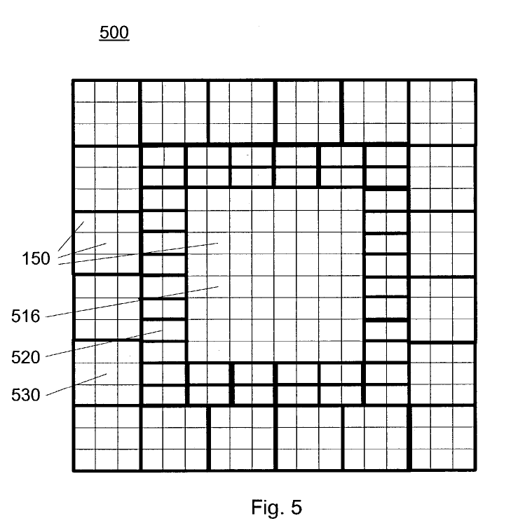

FIG. 5 is an illustration of another exemplary configuration of addressable elements of an array 500, for example, of an SLM, detector array, or other optical system. Array 500 includes an array of uniform sized addressable elements grouped into pixels of different sizes. FIG. 5 is similar to FIG. 2, except that in this example pixels of more than two sizes are created. For example, as light beam intensity gradually decreases from an optical spot, or peak in intensity, the pixel size can be made gradually larger by an appropriate addressing scheme to match the decrease in intensity. Further, different sized pixels can be used for different sizes and/or types of distortions. In particular, array configuration 200 includes a plurality of pixels 516 arranged in a region near the center of array configuration 200. Pixels 516 include a single addressable element 150. Moving away from the center of array 500 pixels 520 of a size larger than pixels 516 are formed of two elements 150. Near the edge of array 500 pixels 530 are formed that include 9 elements 150.

In this example, array 500 allows for pixels of different sizes to be varied according to the variances of the signal or image quality. With multiple sized pixels formed from the uniform sized elements, the pixel size can vary relatively smoothly from one region of the array to another as the intensity of the light varies. The smooth variation of pixel size can reduce variations in the SNR as discussed above as well as increase the information content of the image or detected image with more densely pixilated regions in stronger intensity regions of a light or image beam.

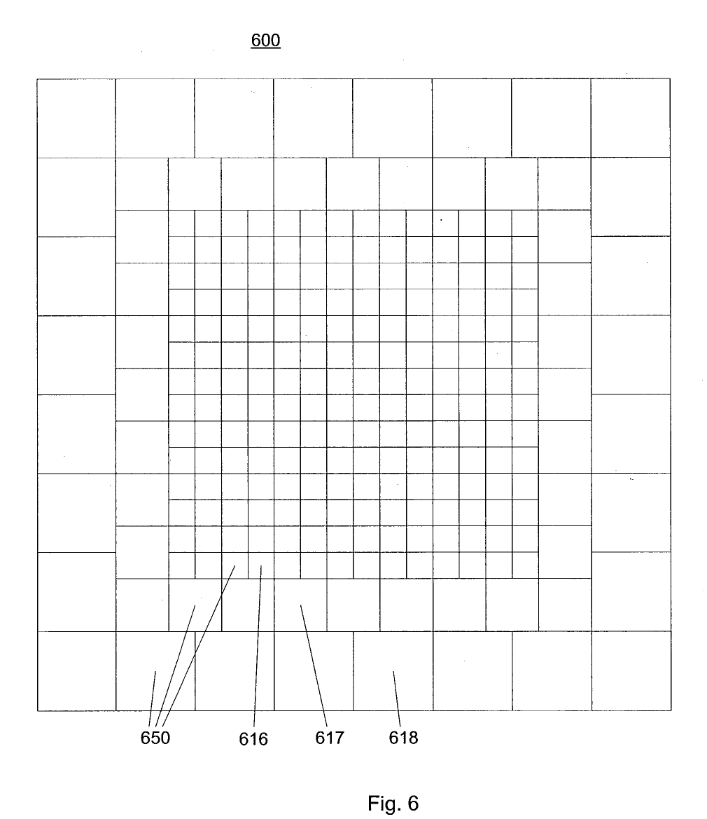

FIG. 6 is an illustration of another exemplary configuration of addressable elements of an array 600, with varying pixel sizes. In this example, array 600 is manufactured with different sized addressable elements 650 that may each correspond to an individual pixel. Thus, instead of grouping equally sized elements into varying sized pixels as in the previous examples, the individual elements 650 of this example are themselves of varying sizes. In this example, the individual elements can be sized more precisely to the variation in the expected optical beam or image. As seen, the middle portion of array 600 has smaller more densely arranged pixels 616. The region of pixels 616 corresponds to high intensity or high quality regions of an incident light beam. In the regions of lower intensity larger pixels 617 and 618 are placed.

As with the previous example, exemplary array 600 allows for different sized pixels, but without the need to group addressable elements into the larger pixels. Therefore encoding and decoding of images or data pages does not require addressing the elements in varying sized groups corresponding to different sized pixels because each element 150 now corresponds to a single pixel or bit of information of an image such as a data page.

It may be desirable, however, to group some of the smaller individual addressable elements 650 of array 600 into larger pixels as done in previous examples. For instance, the cost of custom making an optical system with an array of different sized addressable elements 650 may be high. A manufacturer or purchaser may therefore provide or obtain only a limited number of optical systems with arrays of different sized addressable elements 650, and adjust the pixel sizes further by grouping addressable elements to fit a particular application as described above. In this example, however, the address rates for the pixels, would be varied according to the varying sized pixels.

The above detailed description is provided to illustrate exemplary embodiments and is not intended to be limiting. It will be apparent to those skilled in the art that numerous modification and variations within the scope of the present invention are possible. For example, numerous configurations of addressable elements in varying sizes and shapes are possible. Further, any number and shape of addressable elements may make up the various pixels. Additionally, the various optical systems that may include an array of addressable elements of various sizes or configured into varying sized pixels includes, for example, SLM devices, both reflective and transmissive, micro-mirror devices, detector arrays, cameras, imaging devices, holographic storage systems, printers, and the like. Accordingly, the present invention is defined by the appended claims and should not be limited by the description herein.

We claim:

1. An optical encoding device, comprising:
an array of addressable elements, wherein the addressable elements are addressed in groups of at least one addressable element to form a plurality of pixels, including:
a first set of the pixels of a first size, and
a second set of the pixels of a second size, wherein the second size is larger than the first size.

2. The optical encoding device of claim 1, wherein the addressable elements of the array are uniform in size.

3. The optical encoding device of claim 1, wherein the addressable elements of the array include two or more different sizes.

4. The optical encoding device of claim 1, wherein the pixels of a first size include only one addressable element of the array.

5. The optical encoding device of claim 1, wherein the pixels of a first size include a plurality of addressable elements.

6. The optical encoding device of claim 1, wherein the pixels of a second size include only one addressable element of the array.

7. The optical encoding device of claim 1, wherein the pixels of a second size include a plurality of addressable elements.

8. The optical encoding device of claim 1, wherein at least a portion of the pixels of a first size are located near the center of the array.

9. The optical encoding device of claim 1, wherein there is a distance between adjacent pixels, and the distance is greater between pixels of the second size than between pixels of the first size.

10. The optical encoding device of claim 1, wherein the array of addressable elements are included in a region of a spatial light modulator.

11. A method of using the optical encoding device of claim 1, including:
addressing the array of addressable elements with an encoding unit, wherein the encoding unit addresses the addressable elements in groups of at least one addressable element per group corresponding to the pixels of the first size and the pixels of the second size.

12. The method of claim 11, wherein addressing the array of addressable elements includes encoding a spatial light modulator with a data page.

13. The method of claim 11, wherein a portion of the pixels of a first size are located near regions of the array that receive relatively high intensity light with respect to other regions of the array.

14. The method of claim 11, wherein a portion of the pixels of a second size are located near regions of the array that receive relatively low intensity light with respect to other regions of the array.

15. The method of claim 11, wherein the pixels are arranged more densely near regions of the array that receive relatively high intensity light with respect to other regions of the array.

16. The method of claim 11, wherein an arrangement of the first and second set of pixels increases uniformity of signal-to-noise ratios across the array.

17. The method of claim 11, wherein an arrangement of the first and second set of pixels reduces inter-pixel interference.

18. An optical encoding device, comprising:
an array of addressable elements, wherein the addressable elements of the array include two or more different sizes.

19. The optical encoding device of claim 18, wherein smaller addressable elements are located near the center of the array.

20. The optical encoding device of claim 18, wherein larger addressable elements are located near the edges of the array.

21. The optical encoding device of claim 18, wherein each addressable element corresponds to a single pixel.

22. The optical encoding device of claim 18, wherein there is a distance between adjacent addressable elements, and the distance is greater between larger addressable elements than between smaller addressable elements.

23. The optical encoding device of claim 18, wherein the array of addressable elements are included in a region of a spatial light modulator.

24. An optical decoding device, comprising:
an array of addressable elements, wherein the addressable elements are decoded in groups of at least one addressable element to form a plurality of pixels, including:
a first set of the pixels of a first size,
a second set of the pixels of a second size, and
the second size is larger than the first size.

25. The optical decoding device of claim 24, wherein the addressable elements of the array are uniform in size.

26. The optical decoding device of claim 24, wherein the addressable elements of the array include two or more different sizes.

27. The optical decoding device of claim 24, wherein the pixels of a first size include only one addressable element of the array.

28. The optical decoding device of claim 24, wherein the pixels of a first size include a plurality of addressable elements.

29. The optical decoding device of claim 24, wherein the pixels of a second size include only one addressable element of the array.

30. The optical decoding device of claim 24, wherein the pixels of a second size include a plurality of addressable elements.

31. The optical decoding device of claim 24, wherein at least a portion of the pixels of a first size are located near the center of the array.

32. The optical decoding device of claim 24, wherein there is a distance between adjacent pixels, and the distance is greater between pixels of the second size than between pixels of the first size.

33. The optical decoding device of claim 24, wherein the array of addressable elements includes a detector array.

34. A method of using the optical decoding device of claim 24, including:
addressing the array of addressable elements with a decoding unit, wherein the decoding unit decodes the addressable elements in groups of at least one addressable element per group corresponding to the pixels of the first size and the pixels of the second size.

35. The system of claim 34, wherein each detector element receives varying amounts of light intensity, and decoding includes grouping the information from each detector element into varying sized pixels.

36. The method of claim 34, wherein addressing the array of addressable elements includes decoding a detector array associated with a data page.

37. The method of claim 34, wherein at least a portion of the pixels of a first size are located near regions of the array that receive relatively high intensity light with respect to other regions of the array.

38. The method of claim 34, wherein at least a portion of the pixels of a second size are located near regions of the array that receive relatively low intensity light with respect to other regions of the array.

39. An optical decoding device, comprising:
an array of addressable elements, wherein the addressable elements of the array include two or more different sizes.

40. The optical decoding device of claim 39, wherein smaller addressable elements are located near the center of the array.

41. The optical decoding device of claim 39, wherein larger addressable elements are located near the edges of the array.

42. The optical decoding device of claim 39, wherein each addressable element corresponds to a single pixel.

43. The optical decoding device of claim 39, wherein there is a distance between adjacent addressable elements, and the distance is greater between larger addressable elements than between smaller addressable elements.

44. A holographic storage system, comprising:
a spatial light modulator, including,
an array of individual addressable elements forming a plurality of pixels, wherein, the addressable elements are addressed in groups of at least one addressable element corresponding to the plurality of pixels such that,
a first portion of the pixels are of a first size,
a second portion of the pixels are of a second size, and
the second size is larger than the first size; and
a detector array, including an array of addressable elements.

45. The system of claim 44, wherein the spatial light modulator is encoded with data associated with a data page.

46. The system of claim 45, wherein at least one unit of data of the data page is associated with at least one pixel.

47. The system of claim 44, wherein the addressable elements of the array are uniform in size.

48. The system of claim 44, wherein the addressable elements of the array include two or more different sizes.

49. The system of claim 44, wherein the pixels of a first size include only one addressable element of the array.

50. The system of claim 44, wherein the pixels of a first size include a plurality of addressable elements.

51. The system of claim 44, wherein the pixels of a second size include only one addressable element of the array.

52. The system of claim 44, wherein the pixels of a second size include a plurality of addressable elements.

53. The system of claim 44, wherein at least a portion of the pixels of a first size are located near the center of the array.

54. A system of claim 44, wherein the addressable elements of the detector array are addressed in groups of at least one addressable element to form a plurality of pixels, including:
a third set of the pixels of a third size,
a fourth set of the pixels of a fourth size, and
the fourth size is larger than the third size.

55. A method of using the system of claim 44, comprising:
addressing the array of addressable elements of the detector array with a decoding unit, wherein the decoding unit addresses the addressable elements in groups of at least one addressable element per group corresponding to the pixels of the third size and the pixels of the fourth size.

56. The system of claim 44, wherein the array of addressable elements of the detector array are decoded corresponding to the third and fourth set of pixels.

57. A method for addressing an array of individually addressable elements of an optical system, comprising:
addressing varying numbers of individual elements to form pixels having two or more different sizes.

58. The method of claim 57, wherein the different size pixels include at least a first size and a second size pixel, and the first size and the second size pixels include different numbers of individually addressable elements.

59. The method of claim 58, wherein the first size and the second size pixels include equal numbers of individually addressable elements.

60. The method of claim 57, wherein the addressing the individual elements at varying rates defines the different sized pixels.

61. The method of claim 57, wherein the addressing the individual elements includes encoding a data page to the array, wherein each pixel is associated with a unit of data.

62. The method of claim 57, further comprising:
positioning the array in an optical path; and
decreasing the number of elements per pixel in high intensity regions of the optical path.

63. A method for storing information in a holographic storage device comprising:
providing an object beam and a reference beam;
positioning a spatial light modulator in the object beam;
addressing the spatial light modulator to encode the object beam with a data page associated with information to be stored, wherein the data page includes different sized pixels;
modulating the object beam with the spatial light modulator to create an image of the data page; and
recording an interference pattern of the object beam and the reference beam in a recording material.

64. The method of claim 63, wherein the spatial light modulator is comprised of individual addressable elements, and
the different sized pixels include varying numbers of the individual addressable elements.

65. The method of claim 63, wherein the address rate is varied to configure different numbers of addressable elements of the spatial light modulator as different sized pixels.

66. The method of claim 63, wherein the spatial light modulator is comprised of addressable elements of different sizes corresponding to different sized pixels.

67. The method of claim 63, further comprising:
retrieving the stored information by illuminating the recording material with the reference beam;
receiving the image of the data page at a detector array; and
decoding the image of the data page.

68. The method of claim 67, wherein the decoding rate is varied to address different numbers of elements of the detector array associated with the different sized pixels of the spatial light modulator.

69. The system of claim 67, wherein each detector element receives varying amounts of light intensity, and decoding the data page includes grouping information from each detector element into varying sized pixels.

70. The method of claim 67, wherein the decoding process of the detector array corresponds with the encoding process of the spatial light modulator.
